(19) United States
(12) Patent Application Publication
(10) Pub. No.: US 2026/0131735 A1
(43) Pub. Date: May 14, 2026

(54) POLYMER COMPOSITE STAIR TREAD

(71) Applicant: Airxcel, Inc., Wichita, KS (US)

(72) Inventors: Michael J. LONGEST, Dayton, TN (US); Jonathan R. WINNINGHAM, Crossville, TN (US); Stacey L. SMITH, Dayton, TN (US)

(73) Assignee: Airxcel, Inc., Wichita, KS (US)

(21) Appl. No.: 19/337,320

(22) Filed: Sep. 23, 2025

Related U.S. Application Data
(60) Provisional application No. 63/719,424, filed on Nov. 12, 2024.

(51) Int. Cl. B60R 3/02

(52) U.S. Cl. CPC B60R 3/02

(57) ABSTRACT

A stair tread is provided for attachment to stringers of retractable stairs pivotally mounted in an exterior doorway of a recreational vehicle to allow movement through the exterior doorway between a retracted position stowed within the recreational vehicle and a deployed position outside of the recreational vehicle. The stair tread has a polymer composite tread body that includes a generally planar upper panel, a plurality of slots in the upper panel to permit debris to pass through the upper panel, and at last one channel extending downwardly from the upper panel and extending longitudinally in a direction between a left side edge and a right side edge of the upper panel. A metal support is received in and extends along the first channel and is secured to the stringers to provide strength and rigidity to the polymer composite tread body.

### BACKGROUND

The present disclosure relates generally to retractable stairs and, more particularly, to stair treads used with retractable stairs mounted in an exterior doorway of a recreational vehicle.

Retractable stairs are frequently installed in the exterior doorways of motor homes, travel trailers, caravans, folding camping trailers, truck campers, and other types of recreational vehicles to allow entry to and exiting from the recreational vehicle. The stairs may be moved through the exterior doorway to a stowed position within the recreational vehicle by lifting and pivoting the stairs about a pivot axis. The stairs may then be lowered through the exterior doorway to a deployed position by pivoting in an opposite direction about the pivot axis to place the stairs outside the recreational vehicle where they extend from the exterior doorway toward the ground surface.

Because manual effort is required to lift and pivot the stairs from the deployed position to the stowed position and to lower the stairs from the stowed position to the deployed position, many manufacturers use aluminum extrusions for the stair treads because aluminum is much lighter than steel and has sufficient strength to achieve the desired rigidity and load bearing capacity for the stairs. Slots are typically formed in the aluminum extrusion stair treads to allow water and debris to pass through the stair treads and avoid being carried inside the recreational vehicle when the stairs are placed in the stowed positioned within the recreational vehicle.

Slotted stair treads formed of a polymer composite material are currently used in dock stairs and in one such application rest on and are supported on a metal frame that is attached to the stringers. In another application, the stair treads are attached to the stringers without a supporting metal frame. While it would be desirable to use polymer composite stair treads on stairs as described above that are used with recreational vehicles because of potential cost savings and reductions in weight in comparison to extruded aluminum stair treads, resting the polymer composite stair treads on a metal frame attached to the stringers may undesirably increase the overall thickness of the stair treads in comparison to the aluminum extrusion stair treads and may not achieve significant cost savings. Alternatively, using polymer composite stair treads without resting on a metal support frame may require the use of a high strength polymer composite to achieve the same rigidity and load bearing capacity as the current aluminum extrusion stair treads, thereby offsetting the cost savings that could be achieved with a less expensive, lower strength polymer composite.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, the disclosure is directed to a stair tread for attachment to stair stringers. The stair tread comprises a polymer composite tread body and a first metal support. The polymer composite tread body comprises: a generally planar upper panel having a front edge and a back edge that are spaced apart by a first distance and a left side edge and a right side edge that are spaced apart by a second distance; a plurality of slots in the upper panel to permit debris to pass through the upper panel; and a first channel extending downwardly from the upper panel and extending longitudinally in a direction between the left side edge and the right side edge of the upper panel. The first metal support is received in and extends along the first channel and is constructed for being secured to the stair stringers to provide strength and rigidity to the polymer composite tread body.

In another aspect, the disclosure is directed to retractable stairs for mounting in an exterior doorway of a recreational vehicle. The retractable stairs comprise: first and second stringers positioned in spaced apart and parallel relationship and pivotally mounted to allow movement of the first and second stringers through the exterior doorway between a retracted position stowed within the recreational vehicle and a deployed position outside of the recreational vehicle; at least one stair tread extending between the first and second stringers; and a first metal support. The stair tread comprises a polymer composite tread body and a first metal support. The polymer composite tread body comprises: a generally planar upper panel having a front edge and a back edge that are spaced apart by a first distance and a left side edge and a right side edge that are spaced apart by a second distance; a plurality of slots in the upper panel to permit debris to pass through the upper panel; a grid of support ribs extending downwardly from the upper panel; and a first channel extending downwardly from the upper panel and extending longitudinally in a direction between the left side edge and the right side edge of the upper panel. The first metal support is received in and extends along the first channel and is secured to the stringers to provide strength and rigidity to the polymer composite tread body.

In a further aspect, the disclosure is directed to retractable stairs as describe above and further including a second channel spaced apart from the first channel and extending downwardly from the upper panel and extending longitudinally in a direction between the left side edge and the right side edge of the upper panel; and a second metal support received in and extending along the second channel to provide strength and rigidity to the polymer composite tread body.

### BRIEF DESCRIPTION OF THE DRAWINGS

The present technology is described in detail below with reference to the attached drawing figures, in which like numerals represent the same components, and wherein:

FIG. 1 is a front perspective view of an embodiment of retractable stairs shown in a deployed position outside of a recreational vehicle to allow entry to and exiting from the recreational vehicle;

FIG. 2 is a side elevation view of the retractable stairs in the deployed position;

FIG. 3 is a top, front perspective view of a first embodiment of an individual stair tread;

FIG. 4 is an end elevation view of the first embodiment of the stair tread;

FIG. 5 is an exploded, bottom perspective view of the first embodiment of the stair tread;

FIG. 6 is a bottom plan view of the first embodiment of the stair tread;

FIG. 7 is a top, front perspective view of a second embodiment of an individual stair tread;

FIG. 8 is an end elevation view of the first embodiment of the stair tread;

FIG. 9 is an exploded, bottom perspective view of the second embodiment of the stair tread; and

FIG. 10 is a bottom plan view of the second embodiment of the stair tread.

### DETAILED DESCRIPTION

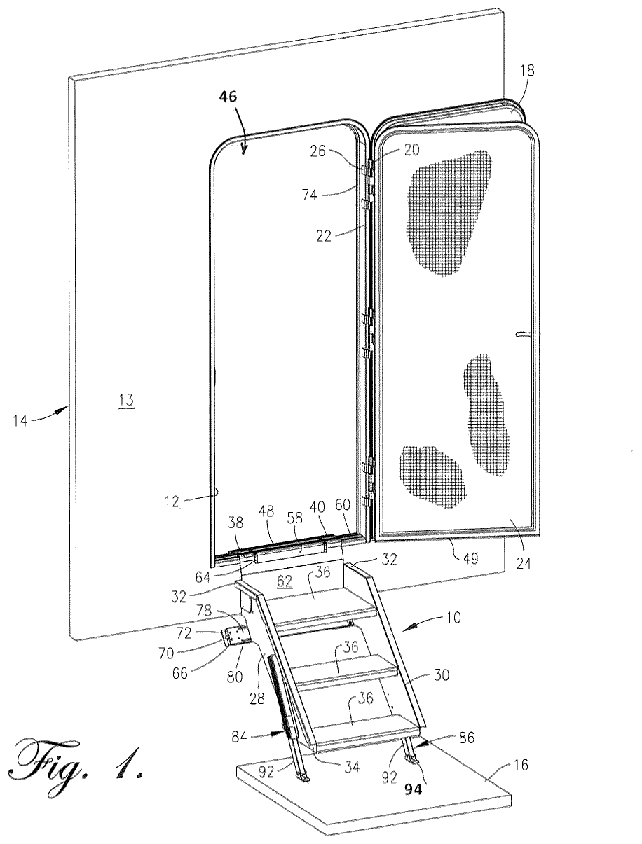

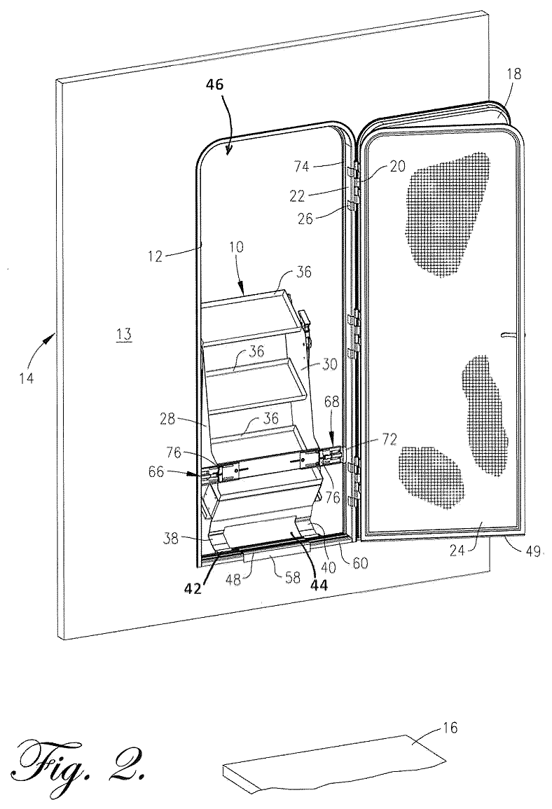

Turning now to the drawings in greater detail and initially to FIGS. 1 and 2, an embodiment of retractable stairs designated generally by the numeral 10 are shown installed in a deployed position extending from an exterior doorway 12 in an exterior wall 13 of a recreational vehicle 14 toward a ground surface 16 to allow entry to and exiting from the recreational vehicle 14. The exterior doorway 12 includes an exterior door 18 mounted by hinges 20 to a door jamb 22. A screen door 24 may also be mounted by hinges 26 to the door jamb 22. Both the exterior door 18 and the screen door 24 may be opened and closed while the retractable stairs 10 are in the deployed position and while the retractable stairs 10 in the retracted stowed position described below.

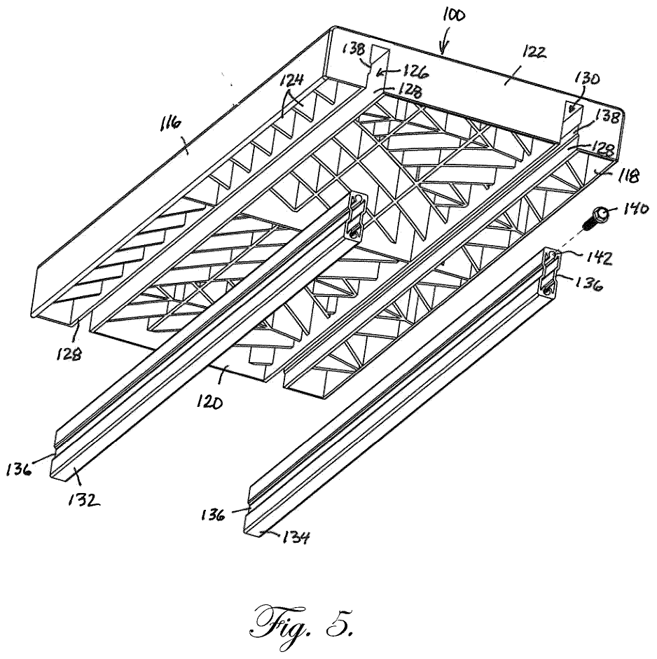

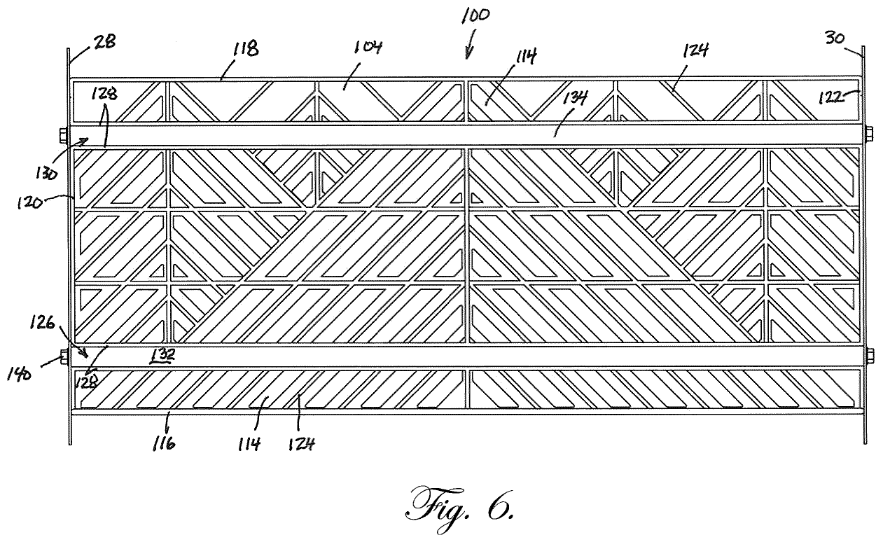

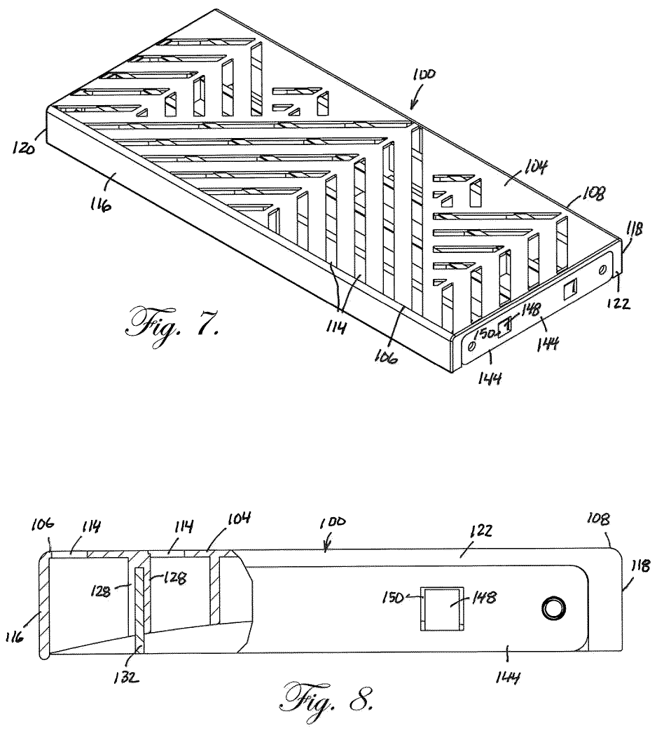

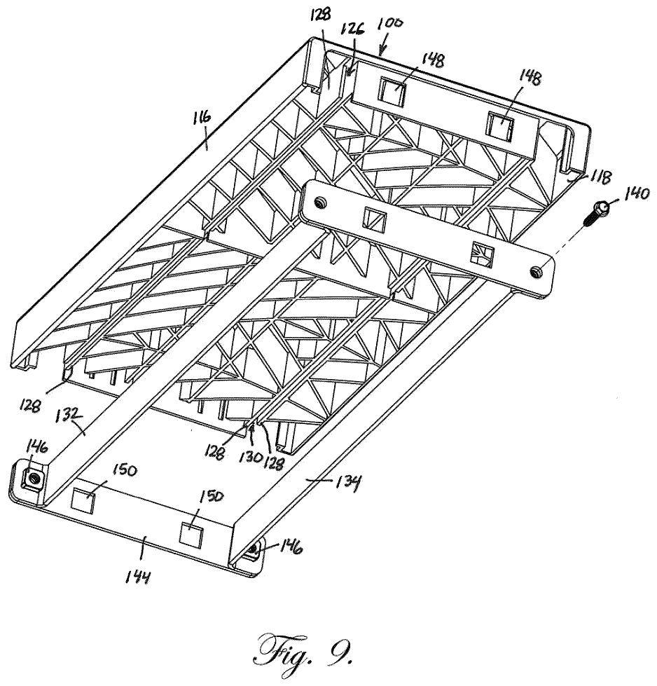

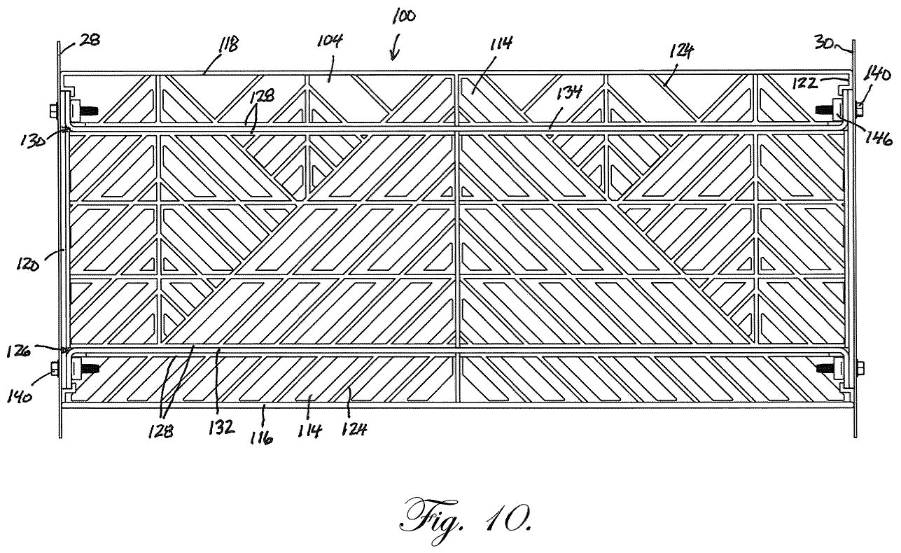

The retractable stairs 10 comprise first and second stringers 28 and 30 that are positioned in spaced apart and parallel relationship to each other, with each having an upper end 32 and a lower end 34. At least one stair tread 36 extends between and is mounted to and supported by the first and second stringers 28 and 30. In the illustrated embodiment, three of the stair treads 36 are used and may be spaced apart so that there is an equal rise between them. In other embodiments, one, two, or four or more stair treads 36 may be used. The structure of the stair treads 36 is shown somewhat schematically in FIGS. 1 and 2, with further details of the stair treads 36 provided in FIGS. 3-10 and in the description below.

The retractable stairs 10 include first and second straps 38 and 40 that are positioned in spaced apart relationship from each other and are coupled at one end with the upper ends 32 of the first and second stringers 28 and 30. The first and second straps 38 and 40 are pivotally coupled at their other ends with brackets 42 that are mounted to a floor 44 in an interior space 46 of the recreational vehicle 14. The pivoting movement of the first and second straps 38 and 40 allows corresponding movement of the first and second stringers 28 and 30 and the stair tread 36 between the deployed position shown in FIG. 1 and a retracted position in which the first and second stringers 28 and 30 and the stair tread 36 have been lifted and pivoted through the exterior doorway 12 for storage within the recreational vehicle 14 as shown in FIG. 5.

When the retractable stairs 10 are in the deployed position extending from the exterior doorway 12 toward the ground surface 16, a portion of the first and second straps 38 and 40 may form part of the threshold underlying the exterior door 18 and the screen door 24 if present. A threshold plate 48 is positioned between the first and second straps 38 and 40 to form an additional and coplanar part of the threshold together with the first and second straps 38 and 40 underlying the exterior door 18 and the screen door 24. The threshold plate 48 may be fixed against movement as the first and second straps 38 and 40 are pivoted to deploy and retract the retractable stairs 10. A brush-like or other type of seal 49 may be attached to the bottom of the screen door 24 and/or the exterior door 18 to impede entry of debris into the interior space 46 of the reactional vehicle 14.

The threshold plate 48 may have an inverted generally “L” shaped cross-sectional profile with a downwardly extending outer flange 58 that extends below a door sill 60. A riser 62 that may be formed as part of, or connected to, the first and second straps 38 and 40 extends between and is connected to the first and second stringers 38 and 40 and extends upwardly from the uppermost stair tread 36. The riser 62 may include a cutout portion 64 that receives the downwardly extending outer flange 58 of the threshold plate 48 when the retractable stairs 10 are in the deployed position.

The retractable stairs 10 may also include a first locking latch 66 that is carried by the first stringer 28 and is operable for releasably securing the first and second stringers 38 and 40 and the stair tread 36 in the retracted position within the recreational vehicle 14, such as during travel of the recreational vehicle 14. A second locking latch 68 may be carried by the second stringer 30 and is also operable for releasably securing the first and second stringers 38 and 40 and the stair tread 36 in the retracted position within the recreational vehicle 14. In one embodiment, the first and second locking latches 66 and 68 are mounted to an underside of, and extend outwardly from, the first and second stringers 38 and 40, respectively. The first and second locking latches 66 and 68 may releasably engage the door jamb 22 to secure the retractable stairs 10 in the retracted stowed position and then allow the retractable stairs 10 to be moved to the deployed position.

The first and second locking latches 66 and 68 may each include a spring-loaded latch 70 and a stop flange 72 that is spaced a preselected distance from the latch 70. The latch 70 is constructed with a sloping side that allows the latch 70 to be depressed when it is brought into engagement with a door stop 74 or other structure carried by the door jamb 22. When the retractable stairs 10 are fully retracted, the stop flange 72 engages against an outer side of the door stop 74 and the latch 70 extends under spring pressure to engage against an inner side of the door stop 74. The door stop 74 is thus captured by the first and second locking latches 66 and 68 to prevent further pivoting movement of the retractable steps 10 either inwardly or outwardly. The retractable steps 10 may be pivoted from the retracted stowed position to the deployed position by a person retracting each latch 70 using a slide handle 76 (FIG. 2).

The first and second locking latches 66 and 68 include mounting brackets 78 that are constructed for allowing be outwardly and inwardly adjustment of the first and second locking latches 66 and 68 to accommodate exterior doorways 12 of different sizes. The mounting brackets 78 may include elongated slots 80 through which bolts or other fasteners (not shown) extend and are secured to the first and second stringers 28 and 30. The fasteners may be loosened to allow movement along the slots 80 and then retightened once the desired positioning is obtained.

The retractable stairs 10 may include a first extensible support leg 84 that is mounted on the first stringer 28 and is extendable downwardly below the lower end 34 of the first stringer 28 to engage the ground surface 16 and provide support for the retractable stairs 10. A second extensible support leg 86 may be mounted on the second stringer 30 and is extendable downwardly below the lower end 34 of the second stringer 30 to also engage the ground surface 16 and provide additional support for the retractable stairs 10. The first and second support legs 84 and 86 may be mounted on the outer sides of the first and second stringers 28 and 30 and positioned so that they extend at a non-parallel angle to the longitudinal length of the first and second stringers 28 and 30. This allows the engagement of the first and second support legs 84 and 86 on the ground surface to be located below the lowermost stair tread 36 rather than extending outwardly beyond the stair tread 36.

Each of the first and second support legs 84 and 86 are operable so that they may extend downwardly in ratcheting increments of about 0.5 inches or less by movement of a ratcheting latch 88 that may be operated by a person's hand or foot. In the illustrated embodiment, each first and second support leg 84 and 86 includes a fixed bracket 90 on which the ratcheting latch 88 is mounted and within which an extendable leg portion 92 is received. The leg portion 92 may include a linear track of teeth (not shown) facing the ratcheting latch 88. The ratcheting latch 88 may include a triple pawl (not shown) that is able to capture two of the teeth at a time by extending into the spacing between adjacent ones of the teeth. The spacing between adjacent teeth is selected to allow the desired extension increments, which may be less about 0.5 inches as noted above, or less than about 0.25 inches.

The ratcheting latch may include a biasing spring (not shown) that exerts a force resisting removal of the pawl from its position capturing the individual one of the teeth. The ratcheting latch may include a thumb lever (not shown) that allows a person to counteract the spring biasing force and release the ratcheting latch 88 from engagement with the track of teeth in order to extend or retract the leg portion 92 within the fixed bracket 90. A foot 94 may be pivotally mounted on a lower end of the leg portion 92 to accommodate a sloping ground surface 16 and to provide a larger support footprint.

A first embodiment of the stair tread 36 is shown in FIGS. 3-6 and a second embodiment of the stair tread is shown in FIGS. 7-10. One or more of the stair treads 36 comprises a polymer composite tread body 100 and metal supports that may be recessed within the polymer composite tread body 100. The polymer used for the polymer composite tread body 100 may, in various embodiments, be a thermoplastic polymer or polymer blend or a thermosetting polymer or polymer blend. Polypropylene is one example of a thermoplastic polymer that may be used as the continuous phase for the polymer composite tread body 100. Reinforcing agents or particles may be added to the polymer matrix to improve the mechanical properties of the polymer, such as the rigidity, strength, toughness, and dimensional stability of the polymer. These reinforcing agents may, in various embodiments, include various fillers such as glass fibers, nanoclay, carbon nanotubes, aromatic polyamide, and rubber. In one embodiment, the polymer composite used in the tread body 100 may be polypropylene and up to 20% by weight glass fibers, including 5 to 15% by weight glass fibers and 8 to 12% by weight glass fibers.

The polymer composite tread body 100 comprises a generally planar upper panel 104 having a front edge 106 and a back edge 108 that are spaced apart by a first distance and a left side edge 110 and a right side edge 112 that are spaced apart by a second distance. In one embodiment, the first distance between the front edge 106 and the back edge 108 is less than the second distance between the left side edge 100 and the right side edge 112. As an example, the first distance may be approximately 8.5 inches and the second distance may be approximately 20 inches. In another example, the first distance may be approximately 13 inches and the second distance may be approximately 23.5 inches. Other dimensions are possible and are within the scope of the disclosure.

A plurality of spaced-apart slots 114 may be provided in the upper panel 104 to permit debris to pass through the upper panel 104 rather than being carried into the interior space 46 of the recreational vehicle 14 when the retractable stairs 10 are moved from the deployed position outside of the recreational vehicle 14 to the retracted position stowed within the recreational vehicle 14. The slots 114 may be arranged in various patterns, such as in the illustrated embodiment where some of the slots 114 extend from the front edge 106 of the upper panel 104 and converge to a midline between the left side edge 100 and the right side edge 112 of the upper panel 104. The remaining slots 114 may be arranged in a similar converging manner in remaining portions of the upper panel 104. The slots 114 may be discontinuous along their longitudinal length. In one embodiment, the slots 114 may have a width, or shortest dimension, within the range of approximately 0.25 inch to approximately 0.5 inch, or approximately ⅜ inch. In one embodiment, the slots 114 may create a total open area of approximately 15 to 40%, approximately 20 to 35%, or approximately 23 to 29% in the upper panel 104.

The polymer composite tread body 100 may include a front wall 116, a back wall 118, a left side wall 120, and a right side wall 122 that are interconnected and extend downwardly from the front edge 106, back edge 108, left side edge 110, and right side edge 112, respectively, of the upper panel 104. In one embodiment, the front wall 116, back wall 118, left side wall 120, and right side wall 122 extend downwardly the same distance and create a thickness for the polymer composite tread body 100 of approximately 1.5 inches.

The polymer composite tread body 100 may include and be reinforced by a grid of support ribs 124 that extend downwardly from an undersurface of the upper panel 104. The support ribs 124 may be arranged so that they do not occlude the slots 114. In one embodiment, the support ribs 124 are arranged so that they are positioned between each of adjacent ones of the slots 114, or between the discontinuous slot segments.

The polymer composite tread body 100 includes a first channel 126 formed by spaced apart channel walls 128 that extend downwardly from undersurface of the upper panel 104 and extending longitudinally in a direction between the left side edge 110 and the right side edge 112 of the upper panel 104. The polymer composite tread body 100 may include a second channel 130 that is spaced apart from and extends parallel to the first channel 126. The first and second channels 126 and 130 may extend through the left and right side walls 120 and 122.

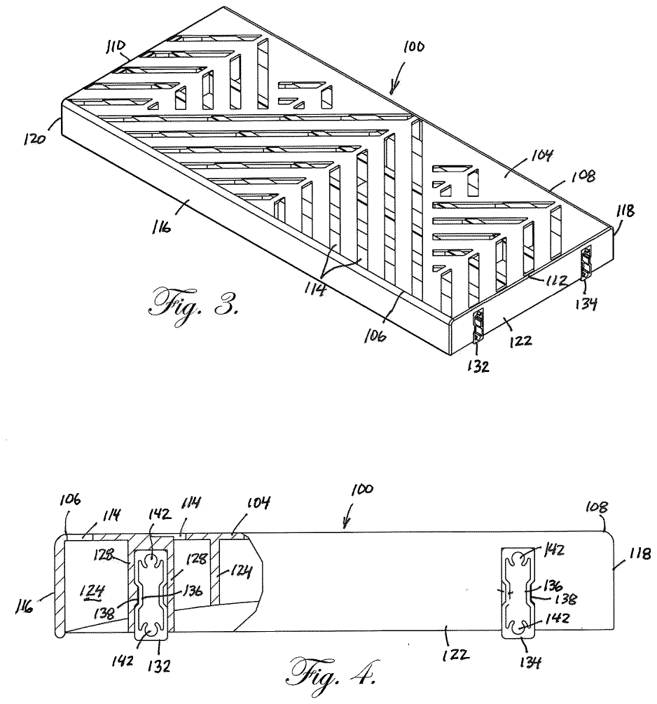

A first metal support 132 is received in and extends along the first channel 126 and is constructed for being secured to the first and second stair stringers 28 and 30 to provide strength and rigidity to the polymer composite tread body 100. A second metal support 134 is similarly received in and extends along the second channel 130 and is constructed for being secured to the first and second stair stringers 28 and 30 to provide additional strength and rigidity to the polymer composite tread body 100. In one embodiment, as shown best in FIG. 4, the first and second metal supports 132 and 134 may be formed from an extruded metal such as aluminum, or a metal alloy. Each of the first and second metal supports 132 and 134 in this embodiment may have a longitudinal groove 136 that receives a longitudinally extending protrusion 138 on a facing surface of one of the channel walls 128 to allow the polymer composite tread body 100 to be snap fit onto the first and second metal supports 132 and 134. The first and second metal supports 132 and 134 may be secured to the first and second stringers 28 and 30 in various fashions, such as by threading a bolt 140 (FIG. 6) through each of the first and second stringers 28 and 30 and into a threaded hole 142 in both ends of the first and second metal supports 132 and 134. In the embodiment shown in FIG. 4, the first and second metal supports 132 and 134 are recessed within and do not extend below the polymer composite tread body 100.

In the embodiment of the first and second metal supports 132 and 134 shown in FIGS. 7-10, end plates 144 are joined to the opposite ends of both the first and second metal supports 132 and 134. Nut 146 may be welded onto the end plates 144 to allow the end plates 144 to be secured to the first and second stringers 28 and 30 by the bolts 140. Snap tabs 148 may be formed in the left side wall 120 and the right side wall 122 of the polymer composite tread body 100 for insertion into complemental openings 150 in the end plates 144 to secure the polymer composite tread body 100 to the end plates 144.

In another embodiment, the polymer composite tread body 100 may be overmolded with various embodiments of the first and second metal supports 132 and 134. Additional metal supports of the disclosed or other embodiments may be used. To provide additional strength and support, some of the support ribs 124 may extend between the channel walls 128 and the front wall 116 and the back wall 118, as well as between the adjacent channel walls 128 of the first channel 126 and the second channel 130.

From the foregoing, it will be seen that this disclosure is one well adapted to attain all the ends and objects set forth above. It will be understood that certain features and sub-combinations are of utility and may be employed without reference to other features and sub-combinations.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and the claim, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Range limitations may be combined and/or interchanged. Such ranges are identified and include all the sub-ranges contained therein unless context or language indicates otherwise.

As used herein, directional references, such as, “top,” “bottom,” “front,” “back,” “side,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

The terms “coupled,” “fixed,” “attached to,” and the like refer to both direct coupling, fixing, or attaching, as well as indirect coupling, fixing, or attaching through one or more intermediate components or features, unless otherwise specified herein.

Although the present application sets forth a detailed description of embodiments of the retractable stairs 10, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

What is claim is:

1. A stair tread for attachment to stair stringers, said stair tread comprising:
a polymer composite tread body comprising:
a generally planar upper panel having a front edge and a back edge that are spaced apart by a first distance and a left side edge and a right side edge that are spaced apart by a second distance;
a plurality of slots in the upper panel to permit debris to pass through the upper panel; and
a first channel extending downwardly from the upper panel and extending longitudinally in a direction between the left side edge and the right side edge of the upper panel; and
a first metal support received in and extending along the first channel and constructed for being secured to the stair stringers to provide strength and rigidity to the polymer composite tread body.

2. The stair tread of claim 1, including:
a second channel spaced apart from the first channel and extending downwardly from the upper panel and extending longitudinally in a direction between the left side edge and the right side edge of the upper panel; and
a second metal support received in and extending along the second channel to provide strength and rigidity to the polymer composite tread body.

3. The stair tread of claim 2, including a grid of support ribs extending downwardly from the upper panel and a front wall extending downwardly from the upper panel along the front edge.

4. The stair tread of claim 3, wherein some of the support ribs extend between the front wall and the first channel.

5. The stair tread of claim 4, including a rear wall extending downwardly from the upper panel along the back edge.

6. The stair tread of claim 5, wherein others of the support ribs extend between the back wall and the second channel.

7. The stair tread of claim 2, wherein each of the first and second channels comprises spaced apart channel walls.

8. The stair tread of claim 7, wherein each of said first and second metal supports has a longitudinal groove that receives a longitudinally extending protrusion on a facing surface of one of the channel walls.

9. The stair tread of claim 8, wherein each of opposite ends of the first and second metal supports has a threaded hole for receiving a threaded fastener.

10. The stair tread of claim 7, including an end plate joined to a first end of both the first and second metal supports and another end plate joined to a second end of the both the first and second metal supports.

11. Retractable stairs for mounting in an exterior doorway of a recreational vehicle, said retractable stairs comprising:
first and second stringers positioned in spaced apart and parallel relationship and pivotally mounted to allow movement of the first and second stringers through the exterior doorway between a retracted position stowed within the recreational vehicle and a deployed position outside of the recreational vehicle;
at least one stair tread extending between the first and second stringers, said stair tread comprising:
a polymer composite tread body comprising:
a generally planar upper panel having a front edge and a back edge that are spaced apart by a first distance and a left side edge and a right side edge that are spaced apart by a second distance;
a plurality of slots in the upper panel to permit debris to pass through the upper panel;
a grid of support ribs extending downwardly from the upper panel; and
a first channel extending downwardly from the upper panel and extending longitudinally in a direction between the left side edge and the right side edge of the upper panel; and
a first metal support received in and extending along the first channel and secured to the stringers to provide strength and rigidity to the polymer composite tread body.

12. The retractable stairs of claim 11, including:
a second channel spaced apart from the first channel and extending downwardly from the upper panel and extending longitudinally in a direction between the left side edge and the right side edge of the upper panel; and
a second metal support received in and extending along the second channel to provide strength and rigidity to the polymer composite tread body.

13. The retractable stairs of claim 12, including a front wall extending downwardly from the upper panel along the front edge.

14. The retractable stairs of claim 13, wherein some of the support ribs extend between the front wall and the first channel.

15. The retractable stairs of claim 14, including a rear wall extending downwardly from the upper panel along the back edge.

16. The retractable stairs of claim 15, wherein others of the support ribs extend between the back wall and the second channel.

17. The retractable stairs of claim 12, wherein each of the first and second channels comprises spaced apart channel walls.

18. The retractable stairs of claim 17, wherein each of said first and second metal supports has a longitudinal groove that receives a longitudinally extending protrusion on a facing surface of one of the channel walls and each of opposite ends of the first and second metal supports has a threaded hole for receiving a threaded fastener.

19. The retractable stairs of claim 17, including an end plate joined to a first end of both the first and second metal supports and another end plate joined to a second end of the both the first and second metal supports.

20. Retractable stairs for mounting in an exterior doorway of a recreational vehicle, said retractable stairs comprising:
first and second stringers positioned in spaced apart and parallel relationship and pivotally mounted to allow movement of the first and second stringers through the exterior doorway between a retracted position stowed within the recreational vehicle and a deployed position outside of the recreational vehicle;
at least one stair tread extending between the first and second stringers, said stair tread comprising:
a polymer composite tread body comprising:
a generally planar upper panel having a front edge and a back edge that are spaced apart by a first distance and a left side edge and a right side edge that are spaced apart by a second distance;
a plurality of slots in the upper panel to permit debris to pass through the upper panel;
a grid of support ribs extending downwardly from the upper panel;
a front wall extending downwardly from the upper panel along the front edge, wherein some of the support ribs extend between the front wall and the first channel;
a rear wall extending downwardly from the upper panel along the back edge, wherein others of the support ribs extend between the back wall and the second channel;
a first channel extending downwardly from the upper panel and extending longitudinally in a direction between the left side edge and the right side edge of the upper panel;
a second channel spaced apart from the first channel and extending downwardly from the upper panel and extending longitudinally in a direction between the left side edge and the right side edge of the upper panel, wherein each of the first and second channels comprises spaced apart channel walls; and
a first metal support received in and extending along the first channel to provide strength and rigidity to the polymer composite tread body; and
a second metal support received in and extending along the second channel to provide strength and rigidity to the polymer composite tread body.
